(19) United States
(12) Patent Application Publication
(10) Pub. No.: US 2016/0210617 A1
(43) Pub. Date: Jul. 21, 2016

(54) METHOD FOR PROCESSING TRANSACTIONAL DATA, CORRESPONDING DEVICES AND COMPUTER PROGRAMS

(71) Applicant: INGENICO GROUP, Paris (FR)

(72) Inventor: Michel Leger, Saint Germain En Laye (FR)

(21) Appl. No.: 14/915,539

(22) PCT Filed: Aug. 26, 2014
(86) PCT No.: PCT/EP2014/068017

§ 371 Date: Feb. 29, 2016

(30) Foreign Application Priority Data
Aug. 29, 2013 (FR) 1358276

(51) Int. Cl. G06Q 20/36; G06Q 20/40; G06Q 20/38

(52) U.S. Cl. CPC G06Q 20/363; G06Q 20/38215; G06Q 20/401; G06Q 20/3829; G06Q 2220/00

(57) ABSTRACT

A method is provided for processing a transaction within a server. The method includes: for receiving a processing request, coming from a payment terminal, connected to the server via a communication network; analyzing the processing request delivering at least one digital wallet identifier and a digital wallet user identifier; implementing a payment transaction from the digital wallet identifier and the digital wallet user identifier and at least one parameter specific to a transaction server associated with the digital wallet identifier, and connected to the server by a communication network; receiving, from the transaction server, a finalizing datum representative of the acceptance or rejection of the transaction; and transmitting said finalizing datum to the payment terminal.

### 1. CROSS-REFERENCE TO RELATED APPLICATIONS

This Application is a Section 371 National Stage Application of International Application No. PCT/EP2014/068017, filed Aug. 26, 2014, the content of which is incorporated herein by reference in its entirety, and published as WO 2015/028435 on Mar. 5, 2015, not in English.

### 2. FIELD OF THE INVENTION

The invention pertains to payment by means of user devices. The invention pertains more particularly to payment by means of a user device comprising means to make a payment through a digital wallet (also called an electronic wallet) which is at least partially associated with the user device. Such a user device can take the form of a mobile terminal.

Payment by mobile terminals is being promoted by numerous actors. This type of payment, designed to be more practical and more secured, takes mainly two forms. The first form uses a specific application of the terminal which contains bank data. This application uses contactless data transmission capacities to get physically connected to a merchant's payment terminal and carry out a payment transaction. This is an alternative to the insertion of a payment card into a payment terminal, with or without use of a pin code. The second form of payment by mobile terminal uses an identifier associated with the user's mobile terminal. This identifier is used by the possessor of the mobile terminal, in conjunction with a PIN code, to validate the transaction on the merchant's payment terminal (here again, this is an alternative to the insertion of a payment card into the merchant's terminal). These types of payment can replace the payment card for making purchases physically.

In addition to this type of use of the mobile terminal, there are uses of modes of payment using electronic wallets. These electronic wallets are often intended for payments of small sums of money to a merchant or again for making Internet payments. In this type of use, a payment service provider, to whom the user of the mobile terminal has entrusted bank data, takes charge of making payment of behalf of the user of the terminal. This payment services provider is often different from the bank establishment of which the user is a customer. To make payments by using this payment service provider, the user has a digital wallet which is installed in his terminal (or in a dedicated payment card). The merchant for his part, when he is an individual, has an application on his terminal associated with the payment services provider to enable validation of the payment. This type of payment using a payment services provider is also done without contact by means of what is called an NFC technology.

### 3. PRIOR ART

Payment services providers who propose electronic wallets each have a special architecture for data processing. The merchant's payment terminal (for example of an NFC type) therefore also needs to have a special application adapted to each payment services provider. Thus, to take two examples, the architecture of the “Google™Wallet” is not the same as the architecture of the “Paypal™ Wallet”.

Indeed, unlike in wallet architectures such as the Google™ or Isis™ architectures, where the credit/debit operations for cards, loyalty offers and information are loaded into and secured in the smartphone or in a micro SD card of the telephone, PayPal™ records its customers' data in a cloud.

The payment application for PayPal™ in the merchant's payment terminal is then completely different from the payment application for Google™ or Isis™. Since the development of payment solutions is done without consultation with the terminal manufacturers, the result is that the manufacturers have to adapt as best as they can to the different ways in which the payment service providers operate.

Concomitantly, there is an increasing number of offers coming from payment service providers. Payment terminal manufacturers, under pressure from the merchants, are therefore obliged to implement numerous special applications in their payment terminals to make sure that merchants can meet their clients' expectations, whatever their payment service provider.

Now, one of the problems encountered relates to the management of fleets of payment terminals. Indeed, when a payment service provider decides to modify the way in which the payment is managed through his digital wallet, the payment terminal manufacturer is then obliged to modify the application used for this provider in every terminal of the fleet. Another problem is the obligation to make sure that a transaction takes place within a given time span. Now, for example in the case of PayPal™, the numerous exchanges that occur in the network (the cloud) in order to carry out the transaction within a given time span make it necessary to have available high-performance communications networks, capable of transmitting and receiving information at high speed. This therefore increases the costs for the merchant of managing the digital wallets without any possibility for this merchant of passing on the cost to the customer. In other words, a part of the cost of processing this type of payment must be borne by the merchant.

There is therefore a need to propose a technique which, on the one hand, simplifies the task of management by manufacturers of terminals and managers of terminal fleets. On the other hand, proposed solution must limit the amount of network resources used to carry out payment operations.

### 4. SUMMARY OF THE INVENTION

The present technique at least partly resolves the above-mentioned problems. In particular, the present technique pertains to a method for processing a transaction within a server called an intermediate server.

The method comprises:
a step for receiving a request for processing coming from a payment terminal connected to said server by means of a communications network;
a step for analyzing said request for processing delivering at least one identifier of a digital wallet and an identifier of a digital wallet user;
a step for implementing a payment transaction on the basis of said identifier of a digital wallet and said identifier of said digital wallet user and of one or more parameters specific to a transactional server associated with said digital wallet identifier and connected to said server by a communications network;
a step for receiving a piece of data, coming from a transactional server, representing acceptance or rejection of the transaction, called a piece of finalizing data;
a step for transmitting this piece of finalizing data to said payment terminal.

Thus, according to the proposed technique, it is not the payment terminal that processes the transaction and its progress. This task is performed by a server, which can be called an intermediate server or a proxy server, to which the payment terminal transmits a standardized request comprising at least some of the data needed to implement the transaction. It is therefore no longer necessary to have a plurality of applications available within the payment terminal, each application being adapted to a particular payment service provider. The optional character of the specific parameters varies according to the requirements of the transactional server.

According to one particular characteristic, said method furthermore comprises a step of decryption of the request for processing by means of a private key proper to said server.

Thus, it is ensured that the content of the request cannot be modified by a third-party entity. The request is first of all encrypted by the payment terminal and then transmitted to the intermediate server.

According to one particular embodiment, said step in which the server implements a payment transaction on the basis of data of said request for processing comprises:
a step of identification, in a data base, of a type of digital wallet associated with a user of a terminal, by means of said digital wallet identifier transmitted by the payment terminal;
a step for obtaining one or more specific parameters necessary for the performance of the transaction;
a step for loading an instance of a particular application intended for managing the transaction with the transactional server;
a step of instantiation of at least one variable corresponding to one or more specific parameters;
a step for supplying said at least one variable to the application in charge of the performance of the transaction;
a step for obtaining a result of the transaction in the form of a piece of finalizing data.

Thus, the intermediate server acts towards the transactional server as if it were a payment terminal. For the transactional server, the transaction is done normally, without any modification of procedures.

According to one particular embodiment, said step of implementation, by the server, of a payment transaction on the basis of the data of said request for processing furthermore comprises:
a step of identification, amongst said one more or specific parameters, of at least one parameter requiring at least one piece of complementary data absent from said server and necessary for the performance of the transaction;
a step for obtaining said at least one piece of complementary data from said payment terminal.

Thus, it is possible, on the part of the payment terminal, to obtain complementary data which can be required to efficiently carry out the transaction from the server.

According to one particular characteristic, said at least one piece of complementary data belongs to the group comprising:
an IP address of said payment terminal; an IP address of a user terminal;
a localizing of said payment terminal;
a transaction amount;
a piece of data representing an account number from which the amount of the transaction must be debited;
the signature of an individual securing code.

The present invention also relates to a server for processing payment transactional data coming from a digital wallet.

Thus, the technique described can be implemented by a server. Such a server for processing a transaction comprises:
means for receiving a request for processing coming from the payment terminal connected to said server by means of a communications network;
means for analyzing said request for processing delivering at least one identifier of a digital wallet and one identifier of a digital wallet user;
means for implementing a payment transaction on the basis of said identifier of a digital wallet and of said identifier of said digital wallet user and of one or more parameters specific to a transactional server associated with said digital wallet identifier, and connected to said server by a communications network;
means for receiving a piece of data coming from the transactional server, this piece of data representing acceptance or rejection of the transaction, and being called a piece of finalizing data;
means for transmitting this piece of finalizing data to said payment terminal.

The present technique also relates to a payment terminal capable of managing payments by using data given by a digital wallet.

The digital wallet can for example take the form of a smartphone which, depending on the architecture, comprises all or part of the data needed to implement the digital wallet. The smartphone can also be replaced by any other device used to fulfill the above-mentioned functions, and especially used to implement a digital wallet, such as a Smartwatch or a pair of Smartglasses, a contactless card (which in this case acts passively) or a 1D or 2D QR-code-based card.

In at least one embodiment, the technique also relates to a method for obtaining transactional data within a payment terminal.

This method comprises the following steps subsequently to a step for obtaining a transactional amount:
a step of initiation, by the payment terminal, of a transaction for paying for a purchase; a step of reception, by means of a data transmission/reception module of the payment terminal, of a digital wallet identifier;
a step of transmission, by means of a data transmission/reception module of the payment terminal, of a user identifier;
a step of encapsulation of said digital wallet identifier and of said user identifier within a request for processing;
a step of transmission of the request for processing to an intermediate server, subsequently to a step for setting up a connection with said intermediate server;
a step of reception of a piece of data for finalizing a transaction.

The proposed technique also relates to a device for obtaining transactional data installed within a payment terminal.

Such a device comprises:
means of initiation, by the payment terminal, of a transaction for paying for a purchase;
means of reception, by means of a data transmission/reception module of the payment terminal, of a digital wallet identifier;
means of transmission, by means of a data transmission/reception module of the payment terminal, of a user identifier;
means of encapsulation, within a request for processing, of said digital wallet identifier and of said user identifier;
means of transmission of the request for processing to an intermediate server, subsequently to means for setting up a connection with said intermediate server;
means for receiving a piece of data for finalizing a transaction.

According to a preferred embodiment, the different steps of the methods according to the invention described are implemented by one or more software programs or computer programs comprising software instructions to be executed by a data processor of a relay module according to the technique described and being designed to control the execution of the different steps by the methods.

The invention is therefore also aimed at providing a program that can be executed by a computer or by a data processor. This program comprises instructions to command the execution of the steps of a method as mentioned here above.

This program can use any programming language whatsoever and can be in the form of a source code, object code or a code that is intermediate between source code and object code, such as in a partially compiled form or in any other desirable form.

The technique described also aims to provide an information carrier readable by a data processor and comprising instructions of a program as mentioned here above.

The information carrier can be any entity or device whatsoever capable of storing the program. For example, the carrier can comprise a storage means such as a ROM, for example a CD ROM or a microelectronic circuit ROM or again a magnetic recording means, for example a floppy disk or a hard disk drive.

Again, the information carrier can be a transmissible carrier such as an electrical or optical signal which can be conveyed via an electrical or optical cable, by radio or by other means. The program according to the invention can be especially uploaded to an Internet type network.

As an alternative, the information carrier can be an integrated circuit into which the program is incorporated, the circuit being adapted to executing or to being used in the execution of the method in question.

According to one embodiment, the invention is implemented by means of software and/or hardware components. In this respect, the term “module” can correspond in this document equally well to a software component and to a hardware component or to a set of hardware and software components.

A software component corresponds to one or more computer programs, one or more sub-programs of a program or more generally to any element of a program or a piece of software capable of implementing a function or a set of functions as described here below for the module concerned. Such a software component is executed by a data processor of a physical entity (terminal, server, gateway, router, etc) and is capable of accessing hardware resources of this physical entity (memories, recording media, communications buses, input/output electronic boards, user interfaces, etc).

In the same way, a hardware component corresponds to any element of a hardware unit capable of implementing a function or a set of functions as described here below for the module concerned. It can be a programmable hardware component or a component with an integrated processor for the execution of software, for example an integrated circuit, a smartcard, a memory card, an electronic board for the execution of firmware, etc.

Each component of the system described here above naturally implements its own software modules.

The different embodiments mentioned here above can be combined with one another to implement the proposed technique.

### 5. LIST OF FIGURES

Other features and advantages of the proposed technique shall appear more clearly from the following description of a preferred embodiment, given by way of a simple illustratory and non-exhaustive example and from the appended drawings, of which:

FIG. 1 is a sequence diagram describing the proposed technology;

FIG. 2 is a sequence diagram describing the implementation of the transaction from the intermediate server;

FIG. 3 is a sequence diagram illustrating a second embodiment of the proposed technique;

FIG. 4 schematically illustrates the technical architecture of an intermediate server;

FIG. 5 schematically illustrates the technical architecture of a payment terminal.

### 6. DETAILED DESCRIPTION OF THE TECHNIQUE DESCRIBED

### 6.1. Reminder of the Technique Described

The general principle of the described technique, as explained here above, consists so to speak in removing the payment terminal from the payment sequence when implementing payment by means of a digital wallet, while at the same time preserving the benefits of the presence of this payment terminal (for example to obtain complementary data, to secure the transaction or quite simply to reassure the merchant and his customers). Indeed, for the merchant who ultimately is the individual most burdened by constraints on the use of electronic wallets (since he must accept every existing wallet), it is important that the payment terminal given to him by his bank should not to be the weak link in the payment sequence. The solution to this problem is to make sure that the payment terminal is not responsible for managing numerous applications for payment by means of a digital wallet. This also brings a definite advantage for the merchant who is not obliged to sign contracts with all the payment services providers. Besides, an intermediate server that replaces the payment terminal fulfils the role of a “meta-merchant” relative to the payment service providers thus simplifying the task of the merchant who no longer has any more than one contract to sign with the manager of the “meta merchant” to accept all types of digital wallets managed by this manager.

Thus, in at least one embodiment of the described technique, rather than having an application adapted to each digital wallet, the invention implements an application called a generic application within the payment terminal. This generic application is capable of obtaining and processing specific data. This generic application comprises means for obtaining at least two pieces of data: a digital wallet identifier (payment service provider's service identification code, which makes it possible to know which is the payment service provider to be contacted to process the transaction) and a user identifier (these two pieces of data are for example transmitted by the user device which may be a smartphone, a contactless card or QR code based card). It can be noted, in an alternative version that the digital wallet identifier can also be selected by the merchant on the payment terminal from a list of payment service providers available through the payment terminal (this list is for example transmitted periodically by an intermediate server).

The service identification code is proper to the payment services provider whose digital wallet is being used. This code is not standardized. Thus, the mobile terminal comprises means for searching for this code among the pieces of data transmitted by the payment application. The user's identifier for its part is not standardized either. However, it is transmitted during the initiation of the payment transaction.

According to the proposed technique, these two pieces of data are transmitted by the payment terminal to an intermediate server which is in a communications network and processes the transmitted data. The processing operations carried out by the intermediate server are chiefly the following: identifying the type of digital wallet used, building a request for processing on the basis of the type of digital wallet identified, this request for processing comprising the user's identifier. The user's identifier is formatted according to the requirements of a transactional server of the payment service provider. The request for processing is then transmitted to the transactional server by the intermediate server, using a dedicated application. Upon reception of the request for processing, the transactional server processes the transaction (i.e. it accepts or does not accept the payment for the user) jointly with the dedicated application of the intermediate user.

Thus, it is no longer the payment terminal that is in charge of managing the transaction with the payment service provider but an intermediate server (or proxy) that receives the data needed to process the transaction. Naturally, depending on the requirements of the transactional servers of the different payment service providers, the pieces of data transmitted are not the same. This means that the intermediate server can either request complementary data from the payment terminal (such as for example the amount of the transaction) or can request complementary information from the user device (when this device is able to do so). This complementary information travels through the payment terminal which then acts as a gateway between the user device and the intermediate server.

Here below we describe two special embodiments for implementing the present technique. It is clear however that these embodiments are not exhaustive but that they represent only one possibility of implementation adapted to an existing technical context. Thus, for example, when the user device is not a smartphone but for example a connected watch, the exchanges that take place between the payment terminal and the connected watch can be significantly different from those existing with a smartphone. What is important for the present technique is to obtain data making it possible to remove the payment terminal while the same time being transparent relative to the user device on the one hand and the transactional server of the payment service provider on the other hand.

### 6.2. Description of One Embodiment

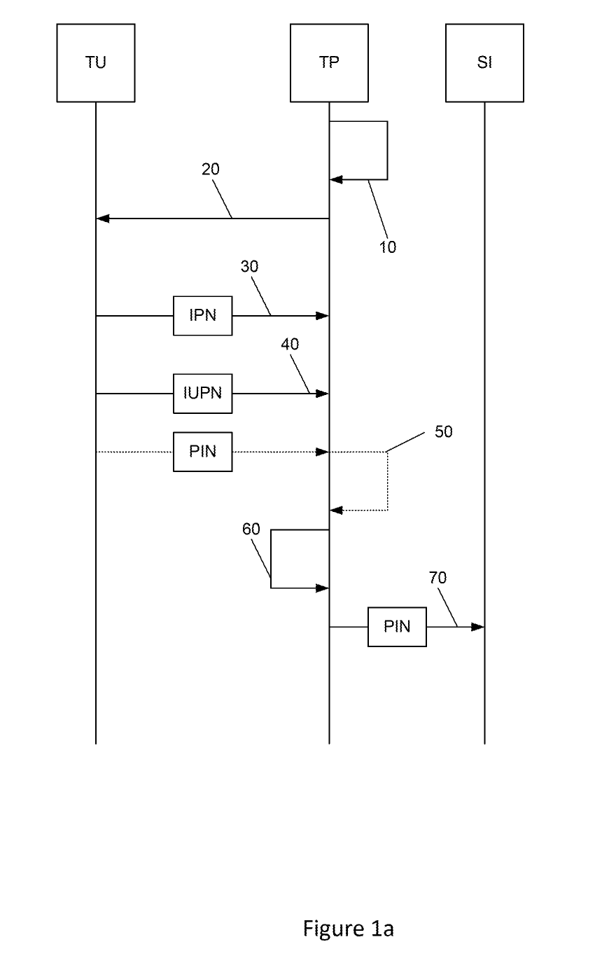

In this embodiment, we describe a process for managing a transaction for purchasing one or more goods or services in the shop of a merchant which is an individual. This process uses a user terminal (TU) playing the role of the user device. This embodiment is described in relation with FIGS. 1a and 1b. The terminal in question (TU) is a smartphone. An initial process which takes place at the payment terminal comprises:
a step (10) for obtaining the price to be paid by means of the merchant's payment terminal (TP);
a step (20) of initiation by the payment terminal (TP) of a transaction aimed at paying for the purchase. This initialization is aimed at enabling the user's terminal to transmit the data needed for payment. It can be done automatically or by an action of the merchant on the terminal. Complementarily, to make it easier for the payment terminal to take charge of the data transmitted by the user terminal, the merchant can advantageously select, from a list of payment service providers, the payment service provider that the user wishes to use. In this case, advantageously, the terminal has available a list of payment service providers that is updated in a centralized manner and transmitted regularly by an intermediate server to the different payment terminals.

Subsequently to this step of initialization:
a step of transmission (30), by means of a data transmission module of the smartphone, of a digital wallet identifier (IPN);
a step of transmission (40), by means of a data transmission module of the smartphone, of a digital wallet user identifier (or user account) (IUPN);
a step of reception, by means of a data transmission/reception module of the payment terminal (TP), of the digital wallet identifier;
a step of transmission, by means of a data transmission/reception module of the payment terminal (TP), of the user's identifier;
an optional step of verification (50) of a match between a value representing a securing code (such as a PIN code) entered by the user on the said payment terminal (TP) and a value representing a securing code present within the user's terminal (TU) (this enables a verification that the user is truly the owner of the terminal that he wishes to use to make the payment). This representative value can be a hash of the PIN code or a signature of this code. Alternatively or complementarily (for example depending on the amount of the transaction), a password or a fingerprint can act as a securing code. These last two possibilities are more worthwhile in terms of security than a PIN code but can be less socially accepted;
a step of encapsulation (60), within a request for processing, of said digital wallet identifier, said user identifier and at least one piece of data representing a transactional amount. Optionally, the value representing the PIN code (or password or fingerprint) can also be encapsulated in the request for processing. This has the advantage of enabling a verification of this data at the server following such verification on the payment terminal (TP). Optionally, the request for processing is encrypted by a public key/private key mechanism: a public key of the intermediate server (SI) is used to encrypt the processing request before its transmission. This has the advantage of reducing the risks of interception and modification of content of the requests for processing. These pairs of public keys/private keys are pairs of temporary keys. A temporary public key of the intermediate server is transmitted regularly or transmitted as a function of need to the payment terminal in order to reduce risks of being compromised;
a step of transmission (70) of the request for processing to the intermediate server (SI) subsequently to a step for setting up a connection with said intermediate server (SI).

From the viewpoint of the intermediate server, the technique that is the object of the present disclosure starts with:
a step of reception (100) of the request for processing by the intermediate server (SI);
optionally, a step of decryption (110) of the request for processing by means of a private key of the intermediate server (SI);
a step of analysis (200) of said request for processing delivering the preliminarily inserted data: digital wallet identifier, user identifier and optionally the amount of the transaction and the signature of the securing code;
a step of implementation (300), by the server, of a payment transaction on the basis of said data of said request for processing and, optionally, at least one piece of data specific to a transactional server (ST) designated by said digital wallet identifier. The optional character of this piece of specific data varies according to the requirements of the transactional server (ST);
a step of reception (400) by the intermediate server (SI), coming from the transactional server (ST), of a piece of data representing acceptance or rejection of the transaction, called a piece of finalizing data;
a step of transmission (500) of this piece of finalizing data to said payment terminal (TP);
a step of finalizing of said transaction by said payment terminal (TP). This step of finalizing can consist of the display, on said terminal, of the piece of finalizing data and the transmission of this piece of finalizing data for example to a cash register for recording the transaction in the accounting system.

Thus, as explained in this sequence of steps, the transaction is conducted from the intermediate server (SI). This server is, in a way, perceived by the transactional server (ST) as being the payment terminal (TP). In this embodiment, which presents a standard situation, the intermediate server (SI) can:
either load and execute an application (AppT) adapted to the transactional server (ST);
or directly include the code enabling the management of a transaction with the transactional server (ST).

This choice can be considered to be a design choice. In reality, it responds to a specific problem: depending on the number of types of transactional servers to be addressed, the management of a general code used to address all types of transactional servers can be complicated. Besides, it can also be envisaged that the payment service providers will each provide their own applications (AppT)s. Thus, the solution that consists in loading and executing an application (AppT) adapted to the transactional server can be a more long-lasting solution.

Besides, depending on the needs of the transactional server (ST) for validating the transaction, additional pieces of data are provided either by the payment terminal (TP) (in this case, these pieces of data are integrated into the request (RqT) transmitted by the payment terminal (TP)), or provided directly by the intermediate server (SI). These pieces of complementary data include especially a localizing of the payment terminal (TP). Indeed, in order to make sure that the user's terminal (TU) is not used fraudulently, the transactional server (ST) may wish to make sure that the payment terminal (TP) and the user's terminal (TU) are situated in identical geographical zones. To this end, the transactional server (ST) can use the IP address of the payment terminal (TP) to obtain a localization (or another piece of data enabling a localization, such as a piece of GPS data or a piece of data for connection to a relay antenna of a GSM type). This means that at least one embodiment of the proposed technique uses a piece of data representing the IP address as a piece of data localizing the payment terminal (TP).

### 6.3. Implementation of a Payment Transaction by the Intermediate Server (SI)

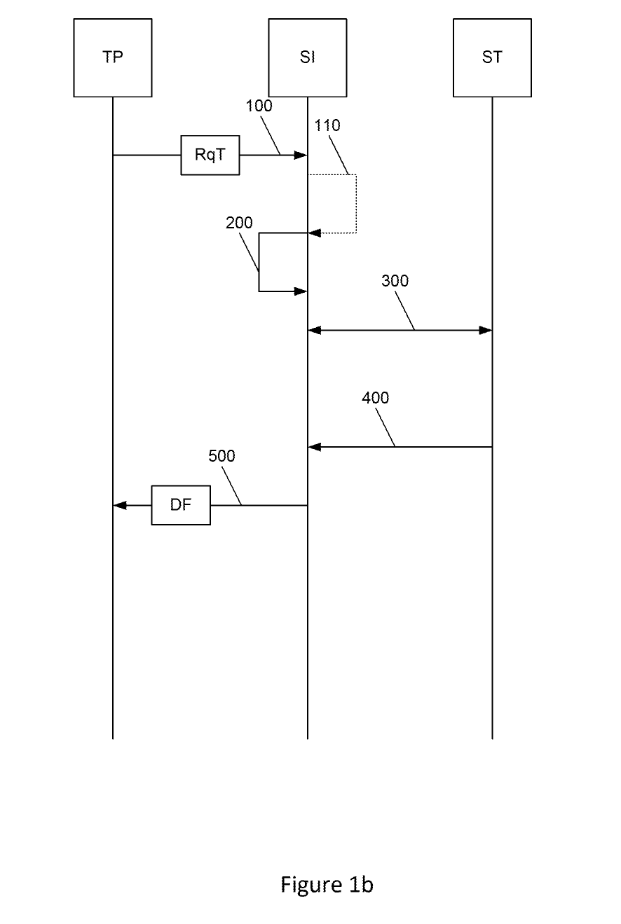

To make the transaction, the intermediate server (SI) emulates the behavior of the payment terminal (TP). Here below, we describe the different steps for implementing this transaction. This description is made with reference to FIG. 2. To this end, the server:
identifies (310) the type of digital wallet associated with the user of the mobile terminal (smartphone) in a data base, or by means of the digital wallet identifier (IPN) transmitted by the payment terminal (TP) or by means of a piece of selection data obtained preliminarily by the merchant;
obtains (320) for example within this data base (BDD), the specific parameters (PrS) needed for the performance of the transaction. In one particular embodiment, the intermediate server (SI) can obtain these parameters (PrS) directly from the identified payment service provider. In this case, the data base comprises at least one network address (for example a URI) enabling access to these parameters;
optionally, asks (325) the payment terminal (TP) for data needed for the performance of the transaction (address, payment mode, payment card used—when the digital wallet comprises several payment cards or again the account number to be used);
optionally, loads (330) an instance of a particular application (AppT) intended to manage the transaction with the transactional server (ST);
instantiates (340) variables corresponding to the parameters needed for the running of the transaction by means of the data obtained from the payment terminal (TP) (user's identifier, optionally the signature of the securing code, amount of the transaction, etc.);
furnishes (350) these variables to the application (AppT) in charge of the performance of the transaction;
retrieves (360) the result of the transaction (assertion of validation or assertion of rejection) also called a piece of finalizing data.

Thus, the intermediate server (SI) presents itself as the payment terminal (TP).

### 6.4. Description of a Second Embodiment

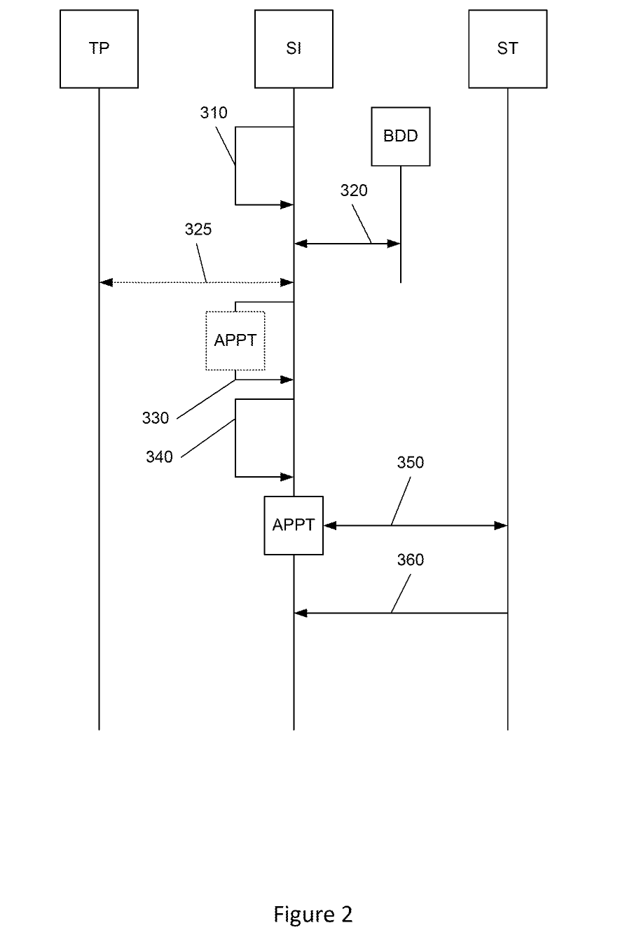

In a second embodiment, the transaction is managed in two stages. This embodiment is described with reference to FIG. 3. The steps are common with the first embodiment and are therefore not described again in this part of the description. Their order is modified. These steps carry the same numbers as in FIG. 1. In a first stage, subsequently to the steps 100 and 200, the intermediate server (SI) directly performs the transaction (it takes the place of the transactional server (ST)—step 300X). On the basis of the data transmitted by the payment terminal (TP), the intermediate server (SI) therefore validates the transaction (the merchant is therefore credited with the sum corresponding to the purchase of the item and the user of the terminal is debited by the same amount). This validation is done by using a data base that serves to record the transactions managed by the intermediate server in the accounting system. For the merchant and for the customer, the payment operation is terminated.

This embodiment has the advantage of not necessitating an excessively lengthy processing time and of being adapted to the environments in which the bit rates of data transmission by network (whether a wired network or a wireless network) are limited.

In a second stage, the intermediate server (SI) makes the transaction (steps 300 and 400) with the transactional server (ST) of the payment service provider. To this end, it uses the application (AppT) adapted to this service provider to make payment. The same data and the same messages are exchanged as in the case of the first embodiment. Thus the intermediate server (SI) retrieves the amount credited to the merchant.

### 6.5. Other Characteristics and advantages

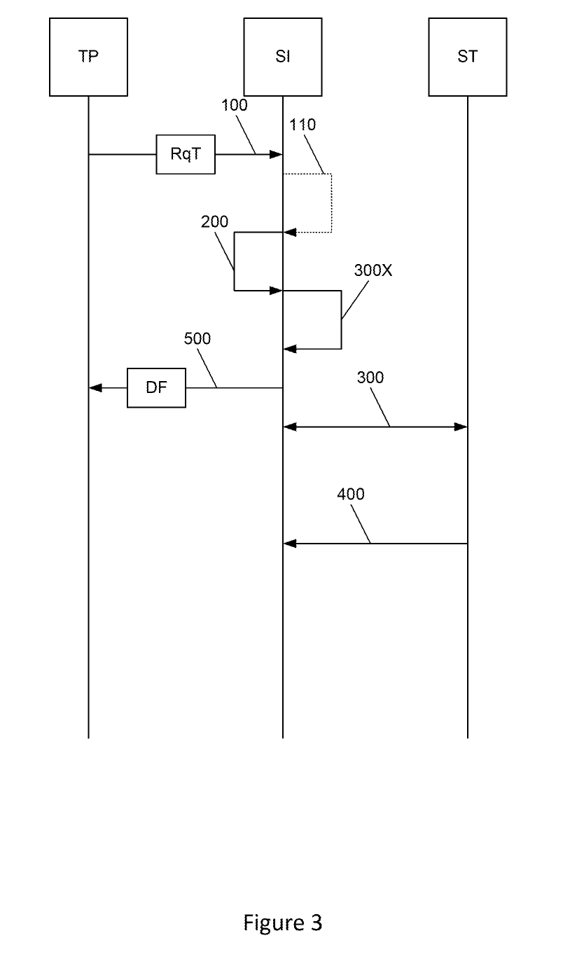

Referring to FIG. 4, we present a simplified architecture of an intermediate server (SI) capable of implementing the technique described. Such a server comprises a memory 41, a processing unit 42 equipped for example with a microprocessor and driven by the computer program 43 implementing at least one part of the method as described. In at least one embodiment, the described technique is implemented in the form of a software application. In another embodiment, the technique described is implemented in a purely hardware form, by means of processors and interfaces specially created for this purposed. Such a server comprises:
means for receiving messages from a payment terminal; optionally, means for decrypting requests for processing by means of a private key of the server;
means for analyzing said request for processing delivering preliminarily inserted data: identifier of the digital wallet, identifier of the user and optionally a transactional amount and security code signature;
means for implementing a payment transaction on the basis of said messages and optionally at least one piece of specific data designated by said digital wallet identifier;
means of reception, from a transactional server (ST), of a piece of data representing acceptance or rejection of the transaction, called a piece of finalizing data;
means for transmitting this piece of finalizing data to said payment terminal (TP).

In at least one embodiment, the described technique can be implemented by means of a communications network to which the server is connected. In at least one embodiment, the described technique is implemented within a plurality of intermediate servers, for example distributed within a territory to be covered.

In at least one embodiment of the invention, the server is associated with a data base. This data base comprises, in addition to the information needed for identification and execution of transactions with transactional servers, data pertaining to merchants. Such data, stored in a secured manner in the data base, makes it possible for example on the basis of an identifier of the payment terminal to obtain the data needed to carry out the transaction on behalf of the merchant. These pieces of “merchant” data are for example the following: merchant's name, physical address, bank particulars, etc.

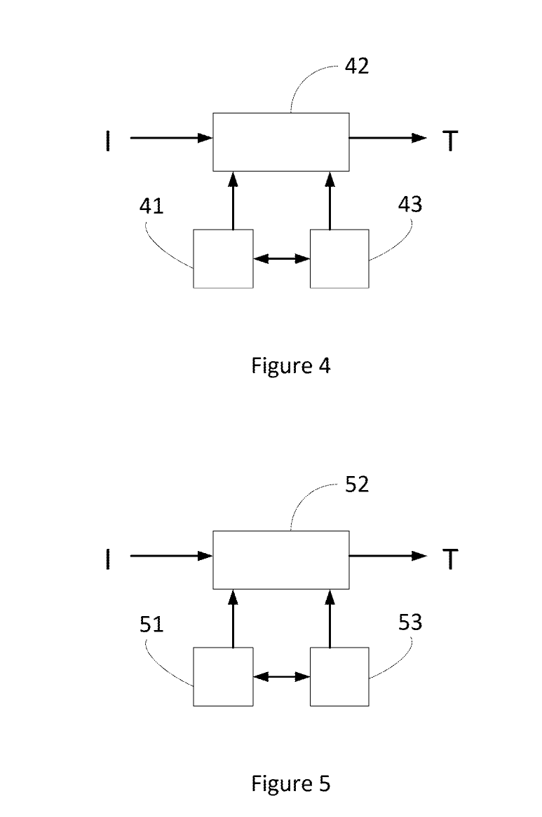

Referring to FIG. 5, we present a simplified architecture of a payment terminal (TP) capable of implementing the technique described. Such a terminal comprises a memory 51, a processing unit 52 equipped for example with a microprocessor and driven by the computer program 53 implementing at least a part of the method as described. In at least one embodiment, the described technique is implemented in the form of a software application. In another embodiment, the described technique is implemented in purely hardware form by means of processors and interfaces specially created for this purpose. Such a terminal comprises:
means for receiving data coming from a terminal of the user. These means can for example consist of a processor and a contactless antenna;
means for obtaining a service identification code and a user identifier. These means can be implemented by a processor of the terminal which, on the basis of the data received by the user's terminal, structures these pieces of data according to several possible structuring schemes; these means can also be implemented as a function of an entry made by the merchant after interrogation of the client on the type of digital wallet that he wishes to use;
means of transmission, in the form of a request, of said data obtained by said user's terminal;
means for receiving a piece of transaction finalizing data.

These means are driven by the microprocessor by means of the program loaded into the memory of the terminal. Depending on the embodiments, the terminal also comprises other means for carrying out exchanges with the intermediate server and enabling the reception, from this server, of temporary encryption keys to carry out data exchanges in a confidential way.

Although the present disclosure has been described with reference to one or more examples, workers skilled in the art will recognize that changes may be made in form and detail without departing from the scope of the disclosure and/or the appended claims.

1. A method for processing a transaction within a processing server, wherein the method comprises:
receiving a request for processing by the processing server coming from a payment terminal connected to said processing server by a communications network;
analyzing said request for processing, delivering at least one identifier of a digital wallet and an identifier of a digital wallet user;
implementing a payment transaction on the basis of said identifier of a digital wallet and said identifier of said digital wallet user and of one or more parameters specific to a transactional server associated with said digital wallet identifier and connected to said processing server by a communications network;
receiving a piece of data, coming from the transactional server, representing acceptance or rejection of the transaction, called a piece of finalizing data; and
transmitting this piece of finalizing data to said payment terminal.

2. The method according to claim 1, further comprising decryption of the request for processing by of using a private key proper to said processing server;

3. The method according to claim 1, the implementation, by the processing server, of a payment transaction on the basis of data of said request for processing comprises:
identification, in a data base, of a type of digital wallet associated with a user of a terminal, by using said digital wallet identifier transmitted by the payment terminal;
obtaining one or more specific parameters necessary for the performance of the transaction;
loading an instance of a particular application intended for managing the transaction with the transactional server;
instantiation of at least one variable corresponding to said one or more specific parameters;
supplying said at least one variable to the application in charge of the performance of the transaction;
obtaining a result of the transaction in the form of a piece of finalizing data.

4. Method according to claim 3, characterized in that said step (300) of implementation, by the processing server, of a payment transaction on the basis of the data of said request for processing furthermore comprises:
a step of identification, amongst said one or more specific parameter (PrS), of at least one parameter requiring at least one piece of complementary data absent from said processing server and necessary for the performance of the transaction;
a step for obtaining said at least one piece of complementary data from said payment terminal (TP).

5. Method according to claim 4, characterized in that said at least one piece of complementary data belongs to the group comprising:
an IP address of said payment terminal;
an IP address of a user terminal;
a localizing of said payment terminal;
a transaction amount;
a piece of data representing an account number from which the amount of the transaction must be debited;
the signature of an individual securing code.

6. A processing sever for processing a transaction, comprising:
means for receiving a request for processing coming from the payment terminal, connected to said processing server by a communications network;
means for analyzing said request for processing delivering at least one identifier of a digital wallet and one identifier of a digital wallet user;
means for implementing a payment transaction on the basis of said identifier of a digital wallet and of said identifier of said digital wallet user and of one or more parameters specific to a transactional server associated with said digital wallet identifier, and connected to said server by a communications network;
means for receiving a piece of data coming from the transactional server, this piece of data representing acceptance or rejection of the transaction, and being called a piece of finalizing data;
means for transmitting this piece of finalizing data to said payment terminal.

7. (canceled)

8. (canceled)

9. A non-transitory computer-readable medium comprising a computer program product stored thereon and executable by a microprocessor of a processing server, wherein the program product comprises program code instructions to execute a method of processing a transaction within the processing server, when the instructions are executed on the microprocessor, wherein the method comprises:
receiving a request for processing by the processing server coming from a payment terminal connected to said processing server by a communications network;
analyzing said request for processing, delivering at least one identifier of a digital wallet and an identifier of a digital wallet user;
implementing a payment transaction on the basis of said identifier of a digital wallet and said identifier of said digital wallet user and of one or more parameters specific to a transactional server associated with said digital wallet identifier and connected to said processing server by a communications network;
receiving a piece of data, coming from the transactional server, representing acceptance or rejection of the transaction, called a piece of finalizing data; and
transmitting this piece of finalizing data to said payment terminal.

10. (canceled)
